(19) United States
(12) Patent Application Publication
(10) Pub. No.: US 2013/0044639 A1
(43) Pub. Date: Feb. 21, 2013

(54) APPARATUS AND METHOD FOR SETTING UP COMMUNICATION RELATIONSHIP

(71) Applicants: Hong Wang, Beijing (CN); Huarui Liang, Beijing (CN); Lixiang Xu, Beijing (CN)

(72) Inventors: Hong Wang, Beijing (CN); Huarui Liang, Beijing (CN); Lixiang Xu, Beijing (CN)

(73) Assignee: SAMSUNG ELECTRONICS CO. LTD., Suwon-si, Gyeonggi-do (KR)

(21) Appl. No.: 13/695,734

(22) PCT Filed: May 11, 2011
(86) PCT No.: PCT/KR11/03460

§ 371 Date: Nov. 1, 2012

(30) Foreign Application Priority Data
May 11, 2010 (CN) 201010170211.1

(51) Int. Cl. H04W 76/02

(52) U.S. Cl. 370/254

(57) ABSTRACT

An apparatus and a method for setting up a communication relationship in a mobile communication system are provided. The method includes determining, by a relay node, whether a new neighboring cell is found, obtaining information of the new neighboring cell, and reporting the same to a Donor evolved Node B (DeNB) that it belongs to, finding, by the DeNB, a network node that the new neighboring cell belongs to, determining whether an X2 interface is set up between the DeNB and the network node that the new neighboring cell belongs to, and if it is determined that the X2 interface is not set up with the network node, setting up the X2 interface with the network node that the new neighboring cell belongs to. It is realized that the relay node can communicate with the network node that the new neighboring node belongs to through the DeNB.

### PRIORITY

This application is a National Stage application under 35 U.S.C. §371 of an International application filed on May 11, 2011 and assigned application No. PCT/KR2011/003460, and claims the benefit under 35 U.S.C. §365(b) of a Chinese patent application filed in the Chinese Intellectual Property Office on May 11, 2010 and assigned Serial No. 201010170211.1, the entire disclosure of which is hereby incorporated by reference.

### BACKGROUND OF THE INVENTION

1. Field of the Invention

The present invention relates to a mobile communication system.

2. Background of the Invention

System Architecture Evolution (SAE) is an evolved technique of a 3rd Generation Mobile Communication System (3GMCS), and mainly includes two parts, such as an Evolved Universal Terrestrial Radio Access Network (E-UTRAN) and a core network and has advantages, such as being capable of increasing a cell capacity, decreasing a system time delay, and the like.

FIG. 1 is a schematic diagram illustrating a composition of an SAE according to the related art.

Referring to FIG. 1, an evolved NodeB (eNB) 110, which is a macro base station, is located in the E-UTRAN, and is used for providing a User Equipment (UE) with a wireless interface for accessing the SAE system. A Mobile Management Entity (MME) 120 and a Serving Gateway (S-GW) 130 are located in the core network, and are connected with the eNB 110 through an S1 interface. Specifically, the MME 120 is mainly used for managing mobile context and session context of the UE and for storing security-related information. The S-GW 130 is mainly used for providing a user-plane function, and for transmitting data to the eNB 110 through a General Packet Radio Service (GPRS) tunnel protocol channel. Thereafter, the data is transmitted to the corresponding UE by the eNB 110. The MME 120 and the S-GW 130 may be located in the same physical entity. In addition, each eNB 110 may be connected with multiple MMEs 120, and may also be connected with multiple S-GWs 130. The eNBs 110 can be connected with each other through an X2 interface.

The UE in a connection mode can move from an eNB to another eNB, and should be noted as a movement from a first eNB to a second eNB. If there is the X2 interface between the first eNB and the second eNB, the first eNB may initiate a handover procedure based on the X2 interface. Specifically, the first eNB transmits a message, in which information required for a handover (e.g., a UE context, and the like) is carried, to the second eNB. The second eNB allocates a resource for the UE and notifies the UE of a configuration of a destination cell. The UE is synchronized with the destination cell and notifies the destination cell after the synchronization is completed. The second eNB transmits a message to the MME, and conducts the handover from an old cell to a new cell for the downlink data tunnel. If there is no X2 interface between the first eNB and the second eNB, the first eNB may initiate a handover procedure based on the S1 interface. For example, the first eNB may first transmit a message to the MME, and perform message forwarding between the first eNB and the second eNB through the MME.

In order to enhance a coverage area at an edge of the cell, a new network node (i.e., a relay node) is introduced in the related art.

FIG. 2 is a schematic diagram illustrating a composition of an SAE added with a relay node according to the related art.

Referring to FIG. 2, an eNB connected by a relay node 200 is known as a Donor evolved Node B (DeNB) 215, and a wireless connection is adopted between the relay node 200 and the DeNB 215. An MME 220 and an S-GW 230 are located in the core network, and are connected with at least one eNB 210 through an S1 interface. The MME 220 and the S-GW 230 may be located in the same physical entity. In addition, each eNB 210 may be connected with multiple MMEs 220, and may also be connected with multiple S-GWs 230. The eNBs 210 can be connected with each other through an X2 interface.

After being powered on, the relay node 200 may first set up a Radio Resource Control (RRC) connection with the DeNB 215. For the DeNB 215, the relay node 200 at this time is equivalent to an ordinary UE. Based on the RRC connection, the S1 and the X2 interfaces can be set up, and the S1 and the X2 interfaces of the relay node 200 are terminated on the relay node 200. The DeNB 215 provides an intermediate proxy function of the S1 and the X2 interfaces between the relay node 200 and another network node. For the relay node 200, the DeNB 215 provides a function similar to the S-GW and a Packet Data Network Gateway (P-GW).

The relay node 200 can set up the X2 interface with the DeNB and also needs to set up the X2 interface with another neighboring node, i.e., a network node which belongs to a neighboring cell of the relay node 200. It is assumed that the neighboring node of the relay node 200 is a third eNB. In the related art, if the DeNB 215 has set up the X2 interface with the third eNB, and the relay node 200 sets up the X2 interface with the DeNB 215 after being powered on, the relay node 200 sets up the X2 interface with the third eNB as a result. Accordingly, the relay node 200 can communicate with the third eNB through forwarding by the DeNB 215.

Typically, by way of a network configuration, the X2 interface may be set up between the DeNB and every neighboring node of the relay node. However, if the relay node finds a new neighboring cell and the X2 interface is not set up between the DeNB and the network node that the new neighboring cell belongs to but the relay node wants to communicate with the network node, the relay node may first transmit a message to the DeNB to request setting up the X2 interface. However, according to a processing manner of the related art, information on an object with which the X2 interface is specifically set up may not be carried in the message. After receiving the message, the DeNB may only consider that this message is transmitted to itself, and may not set up the X2 interface with another network node. As a result, the relay node may not be able to communicate with the network node that belongs to the new neighboring cell.

Therefore, a need exists for an apparatus and a method for setting up a communication relationship in a mobile communication system.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for setting up a communication relationship in a mobile communication system.

Another aspect of the present invention is to provide an apparatus and a method for setting up an X2 interface between a network node located in a neighboring cell and an evolved Node B (eNB) that a relay node is subordinate to in a mobile communication system.

Another aspect of the present invention is to provide an apparatus and a method for providing changed information of a relay node to a network node located in a neighboring cell in a mobile communication system.

Another aspect of the present invention is to provide an apparatus and a method for providing changed information of a network node located in a neighboring cell to a relay node in a mobile communication system.

In accordance with an aspect of the present invention, a method for setting up a communication relationship in a mobile communication system is provided. The method includes obtaining information by a relay node, of a new neighboring cell, and reporting the information of the new neighboring cell to a Donor evolved Node B (DeNB) that the relay node belongs to, and finding, by the DeNB, a network node that the new neighboring cell belongs to, determining whether an X2 interface is set up between the DeNB and the network node that the new neighboring cell belongs to, and if it is determined that the X2 interface is not set up with the network node, setting up the X2 interface with the network node that the new neighboring cell belongs to.

In accordance with an aspect of the present invention, a method for an operation of a relay node in a mobile communication system is provided. The method includes obtaining information of a new neighboring cell, and reporting the information of the new neighboring cell to a DeNB that the relay node is subordinate to.

In accordance with an aspect of the present invention, a method for an operation of an eNB in a mobile communication system is provided. The method includes finding a network node that a new neighboring cell belongs to when information of the new neighboring cell is reported from a relay node subordinate to the eNB, determining whether an X2 interface is set up between the eNB and the network node that the new neighboring cell belongs to, and setting up the X2 interface with the network node that the new neighboring cell belongs to upon determining that the X2 interface is not set up.

In accordance with an aspect of the present invention, an apparatus for operating a relay node in a mobile communication system is provided. The apparatus includes a controller for obtaining information of a new neighboring cell, and a modem for reporting the information of the new neighboring cell to a DeNB that the relay node is subordinate to.

In accordance with an aspect of the present invention, an apparatus for operating an eNB in a mobile communication system is provided. The apparatus includes a modem for receiving information of a new neighboring cell from a relay node subordinate to the eNB, and a controller for finding a network node that the new neighboring cell belongs to, for determining whether an X2 interface is set up between the eNB and the network node that the new neighboring cell belongs to, and for setting up the X2 interface with the network node that the new neighboring cell belongs to upon determining that the X2 interface is not set up.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating a composition of a System Architecture Evolution (SAE) according to the related art;

FIG. 2 is a schematic diagram illustrating a composition of an SAE added with a relay node according to the related art;

FIG. 3 is a signaling diagram illustrating a communication relationship set up process according to an exemplary embodiment of the present invention;

FIG. 4 is a signaling diagram for notifying an evolved Node B (eNB) when configuration information and/or load information of a relay node is changed according to an exemplary embodiment of the present invention;

FIG. 5 is a signaling diagram for notifying a relay node when configuration information and/or load information of an eNB is changed according to an exemplary embodiment of the present invention;

FIG. 6 is a schematic diagram illustrating a network deployment situation according to an exemplary embodiment of the present invention;

FIGS. 7 and 8 are flowcharts illustrating a processing manner after a Donor evolved Node B (DeNB) receives an eNB state update message according to an exemplary embodiment of the present invention;

FIG. 9 is a block diagram of a relay node in a mobile communication system according to an exemplary embodiment of the present invention;

FIG. 10 is a block diagram of an eNB in a mobile communication system according to an exemplary embodiment of the present invention; and

FIG. 11 is a block diagram of a Mobile Management Entity (MME) in a mobile communication system according to an exemplary embodiment of the present invention.

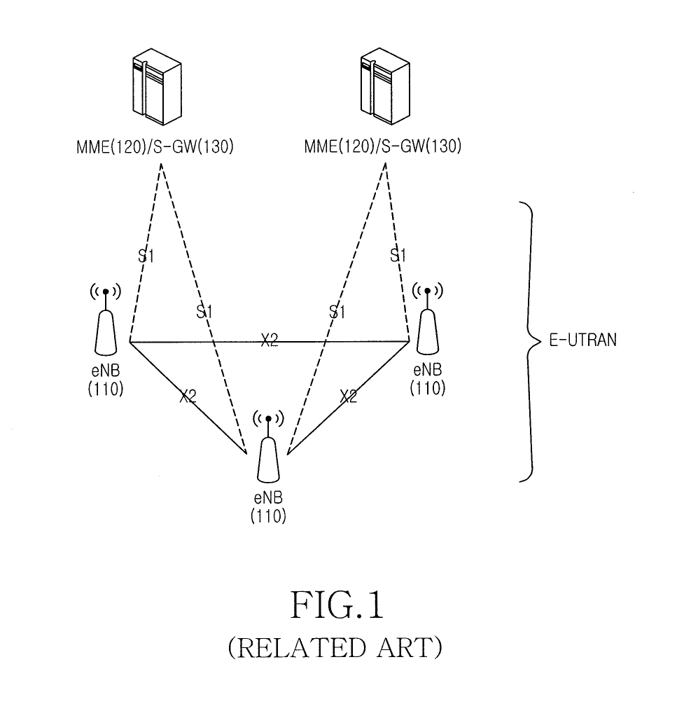

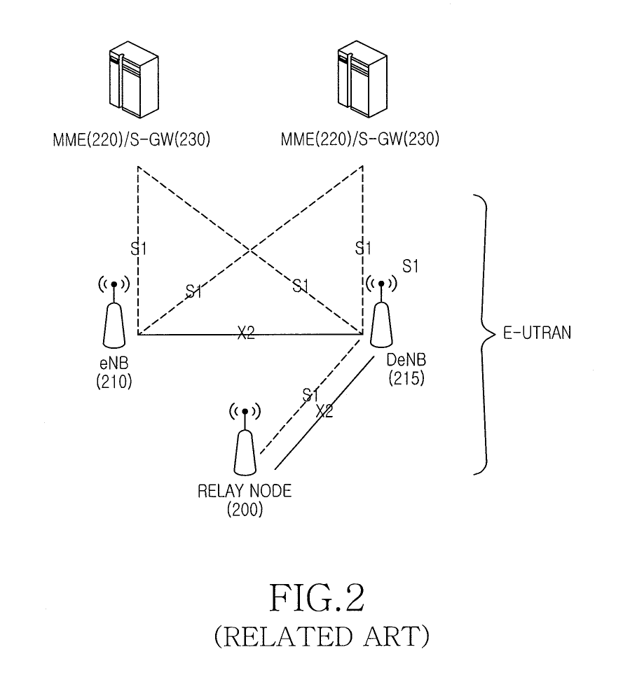

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present invention relates to an apparatus and a method for setting up a communication relationship in a mobile communication system. An exemplary embodiment of the present invention provides a method for setting up a communication relationship, wherein a relay node determines that a new neighboring cell is found, and transmits information of the new neighboring cell to a Donor evolved Node B (DeNB) that the relay node belongs to. The DeNB finds a network node that belongs to the new neighboring cell, determines whether an X2 interface has been set up between the DeNB and the network node, and sets up the X2 interface with the network node upon determining that the X2 interface has not been set up.

Hereinafter, exemplary embodiments of the present invention will be described with reference to the accompanying drawings. In the following description, the same elements will be designated by the same reference numerals although they are shown in different drawings, and the repeated description will be omitted.

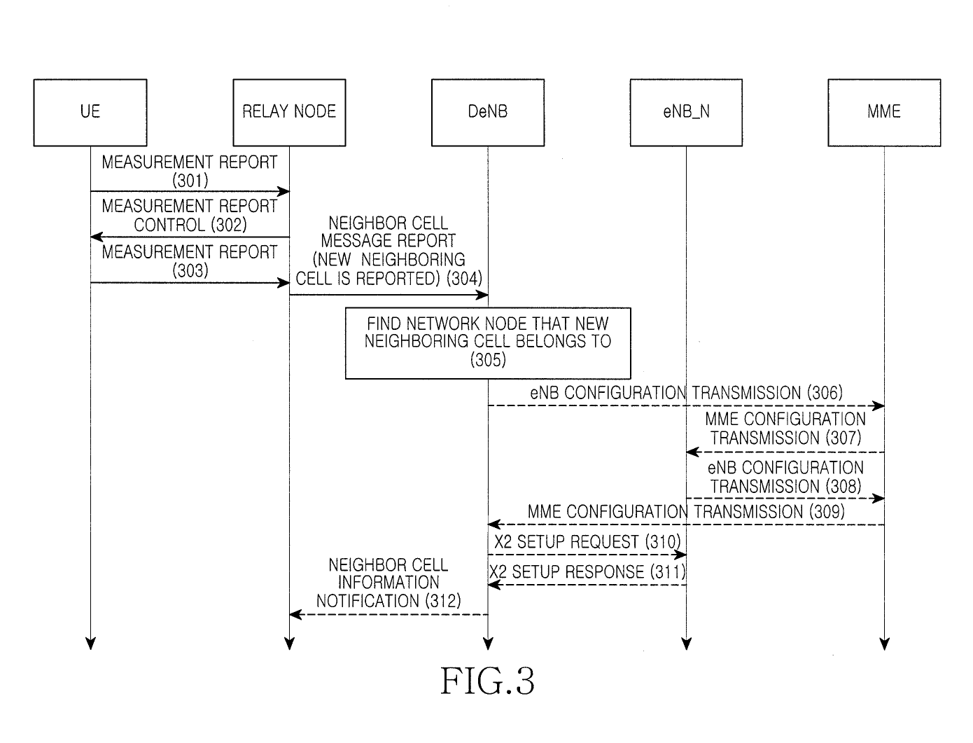

FIGS. 3 through 11, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 3 is a signaling diagram illustrating a communication relationship set up process according to an exemplary embodiment of the present invention. Hereinafter, it should be noted that the relay node has set up the X2 interface with the DeNB that it belongs to when being powered on.

Referring to FIG. 3, in step 301, the relay node receives a measurement report transmitted from a subordinate User Equipment (UE), and determines whether the new neighboring cell is found according to a physical-layer identifier of the neighboring cell that is carried in the measurement report. In an exemplary embodiment, every UE may transmit the measurement report to the relay node that it belongs to periodically or when a predefined condition is met. After receiving the measurement report transmitted from the UE, the relay node obtains the physical-layer identifier of the neighboring cell that is carried in the measurement report, and determines whether the obtained physical-layer identifier of the neighboring cell is presented in a neighboring cell list that it stores in advance. If it is determined that the physical-layer identifier of the neighboring cell that is carried in the measurement report is not presented in the neighboring cell list, the relay node determines that the neighboring cell corresponding to the physical-layer identifier not presented in the neighboring cell list is the new neighboring cell. For example, cells subordinate to different relay nodes subordinate to the same DeNB may be neighboring cell to each other. In addition, the cell subordinate to an ordinary eNB may also be the neighboring cell of the relay node. Additionally, the cell subordinate to the DeNB may also be the neighboring cell of the relay node subordinate to the DeNB. Moreover, the cell subordinate to the relay node may be the neighboring cell of the DeNB that the relay node belongs to, and is stored in the neighboring cell list of the DeNB.

In step 302, the relay node transmits a measurement report control to the UE, to notify the UE to report the information of the new neighboring cell. For example, the relay node requests to report the information of the new neighboring cell. Specifically, the relay node transmits the measurement report control to the UE transmitting the physical-layer identifier of the new neighboring cell, to notify the UE to report the information of the new neighboring cell, which includes an Evolved Universal Terrestrial Radio Access Network (E-UTAN) Cell Global Identifier (ECGI), a Tracking Area Code (TAC), a Public Land Mobile Network Identifier (PLMN ID), and the like. The UE may obtain the information described above by receiving a broadcast message of the new neighboring cell.

In step 303, the UE transmits the obtained information of the new neighboring cell to the relay node through a measurement report. For example, the UE transmits the measurement report including the information of the new neighboring cell to the relay node.

In step 304, the relay node adds the information of the new neighboring cell into a neighboring cell list of the relay node, and transmits a neighboring cell message report to the DeNB that the relay node is subordinate to, to transmit the information of the new neighboring cell to the DeNB. Specifically, the relay node transmits the neighboring cell message report to the DeNB, to report that the new neighboring cell is found and transmit the information of the new neighboring cell, i.e., the above-mentioned ECGI, TAC and PLMN and the like, to the DeNB.

In step 305, the DeNB stores the received information of the new neighboring cell, finds the network node that the new neighboring cell belongs to, i.e., an eNB_N, and determines whether the X2 interface has been set up between the DeNB and the eNB_N. If it is determined that the X2 interface has been set up, step 312 is executed and the procedure ends. Otherwise, step 306 is executed. In exemplary embodiments of the present invention, in addition to DeNB's own neighboring cell list, the neighboring cell list of every subordinate relay node may also be stored in the DeNB. In this case, after receiving the information of the new neighboring cell, the DeNB can store the information of the new neighboring cell into the neighboring cell list of the relay node which transmits the information of the new neighboring cell. The DeNB finds the network node that the new neighboring cell belongs to, where the network node may be another relay node (e.g., located under the same DeNB or different DeNBs) and may also be the ordinary eNB, i.e., the eNB_N, and determines whether the X2 interface has been set up between the DeNB and the eNB_N. If it is determined that the X2 interface has not been set up between the DeNB and the eNB_N, step 306 is executed to start setting up the X2 interface. The method by which the DeNB finds the eNB_N and determines whether the X2 interface has been set up with the eNB_N are related to the related art, and a description thereof is omitted.

In step 306, the DeNB transmits an eNB configuration transmission message to an MME. The eNB configuration transmission message includes a base station identifier, PLMN ID and TAC of the DeNB, and the base station identifier, PLMN ID and TAC of the eNB_N as well as an indication for requesting a transmission-layer address of the eNB_N.

In step 307, the MME transmits an MME configuration transmission message to the eNB_N. Contents included in the MME configuration transmission message are identical to those included in the eNB configuration transmission message in step 306. For example, the MME configuration transmission message includes a base station identifier, PLMN ID and TAC of the DeNB, and the base station identifier, PLMN ID and TAC of the eNB_N, and an indication for requesting a transmission-layer address of the eNB_N.

In step 308, the eNB_N transmits a response message, i.e., the eNB configuration transmission message, to the MME. In the eNB configuration transmission message, the base station identifier, PLMN ID and TAC of the DeNB, and the base station identifier, PLMN ID and TAC of the eNB_N are carried, and the transmission-layer address of the eNB_N is also carried.

In step 309, the MME transmits the MME configuration transmission message to the DeNB. The contents included in the MME configuration transmission message are identical to those included in the eNB configuration transmission message in step 308. For example, the MME configuration transmission message includes the base station identifier, PLMN ID and TAC of the DeNB, and the base station identifier, PLMN ID and TAC of the eNB_N, and the transmission-layer address of the eNB_N.

In step 310, the DeNB transmits an X2 setup request message to the eNB_N.

Upon obtaining the transmission-layer address of the eNB_N, the DeNB transmits the X2 setup request message to the eNB_N. The X2 setup request message includes the information of the cell subordinate to the DeNB, and optionally, the information of the neighboring cell of the DeNB and information, such as a pool that the DeNB belongs to.

In step 311, the eNB_N transmits an X2 setup response message to the DeNB. The X2 setup response message includes the information of the cell subordinate to the eNB_N, and optionally, the information of the neighboring cell of the eNB_N and information, such as a pool that the eNB_N belongs to.

In step 312, the DeNB transmits a neighboring cell information notification message to the relay node, and the procedure ends. The information of the cell subordinate to the eNB_N that is to be obtained during an X2 interface setup can optionally also include the information of the neighboring cell of the eNB_N and the information, such as the pool that the eNB_N belongs to, to transmit the same to the relay node. The method of setting up the X2 interface of this exemplary embodiment is related to the method of the related art, and a description thereof is omitted.

It can be seen based on the explanation described above that in exemplary embodiments of the present invention, after finding the new neighboring cell, the relay node may report it to the DeNB that it belongs to. Accordingly, the DeNB finds the network node that the new neighboring cell belongs to, determines whether the X2 interface has been set up between the DeNB and the network node, and if it is determined that the X2 interface has not been set up between the DeNB and the network node, sets up the X2 interface with the network node. Consequently, the relay node can subsequently communicate with the network node that the new neighboring cell belongs to through the DeNB.

In addition, in the related art, when configuration information and/or load information of the relay node is changed, e.g., when a load of a certain resource block exceeds a limit, it may be required to notify the relay node's neighboring node, e.g., the eNB_N, so that the neighboring node does not schedule this resource block. In accordance with the processing manner of the related art, the relay node may first transmit a message to the DeNB, expecting that the DeNB forwards the message. However, the DeNB may only consider that the message is transmitted to itself, i.e., the relay node notifies the DeNB that the load of a resource block exceeds the limit but does not transmit the same to the eNB_N. As a result, the eNB_N may continue scheduling the resource block. Thus performance of the relay node, the eNB_N, and respective subordinate UEs may be affected. In addition, if configuration information and/or load information of the eNB_N is changed, it may also be required to notify the relay node. Accordingly, performance of the relay node, the eNB_N, and respective subordinate UEs may be affected.

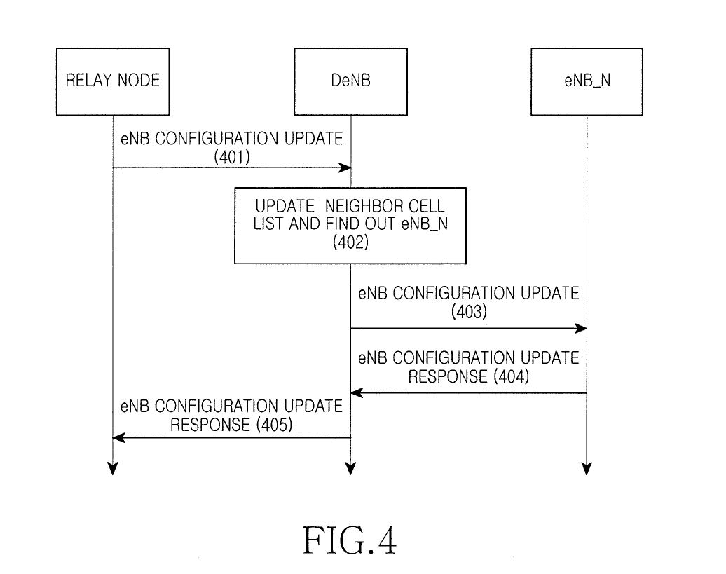

It can be known in light of the previous explanation that, in addition to its own neighboring cell list, the neighboring cell list of every subordinate relay node may also be stored in the DeNB. Accordingly, the performance issue described above can be addressed by the exemplary embodiments illustrated in FIGS. 4 through 7.

FIG. 4 is a signaling diagram for notifying an eNB when configuration information and/or load information of a relay node is changed according to an exemplary embodiment of the present invention. Here the eNB_N is only exemplary, and the neighboring node, such as another relay node, and the like, is also possible.

Referring to FIG. 4, in step 401, the configuration information and/or load information of the relay node is changed, and an eNB configuration update message is transmitted to the DeNB that the relay node belongs to. In this step, if the configuration information, such as a cell frequency of the relay node and/or the load information, is changed, the relay node may transmit an eNB state update message, in which the changed configuration information and/or load information are carried or an interference on different resource blocks by the neighboring cell can be carried, to the DeNB that it belongs to. The eNB state update message can specifically refer to a currently defined eNB load state message or the eNB configuration update message of an X2 message. It should be noted that another message, such as an eNB configuration update message, is also feasible.

In step 402, the DeNB updates a neighboring cell list of the DeNB according to the received eNB configuration update message, and determines the network node that every neighboring cell in the neighboring cell list of the relay node transmitting the eNB state update message belongs to, i.e., the eNB_N. In this step, since the cell of the relay node is the neighboring cell of the DeNB that the relay node is subordinate to, the DeNB needs to update a neighboring cell list of the relay node. In addition, from the neighboring cell list of every subordinate relay node that the DeNB stores, the DeNB finds the neighboring cell list of the relay node transmitting the eNB configuration update message, and finds the network node that every neighboring cell in the neighboring cell list belongs to, i.e., the eNB_N.

In step 403, the DeNB forwards the received eNB configuration update message to the eNB_N.

In step 404, the eNB_N updates a neighboring cell list of the eNB_N according to the received eNB configuration update message, and transmits an eNB configuration update response message to the DeNB after the update is completed.

In step 405, the DeNB transmits the eNB configuration update response message to the relay node. For example, the eNB configuration update response message is transmitted to the relay node transmitting the eNB configuration update message. This step can also be executed before the step 402, i.e., after the eNB configuration update message transmitted from the relay node is received, the eNB configuration update response message is returned to the relay node.

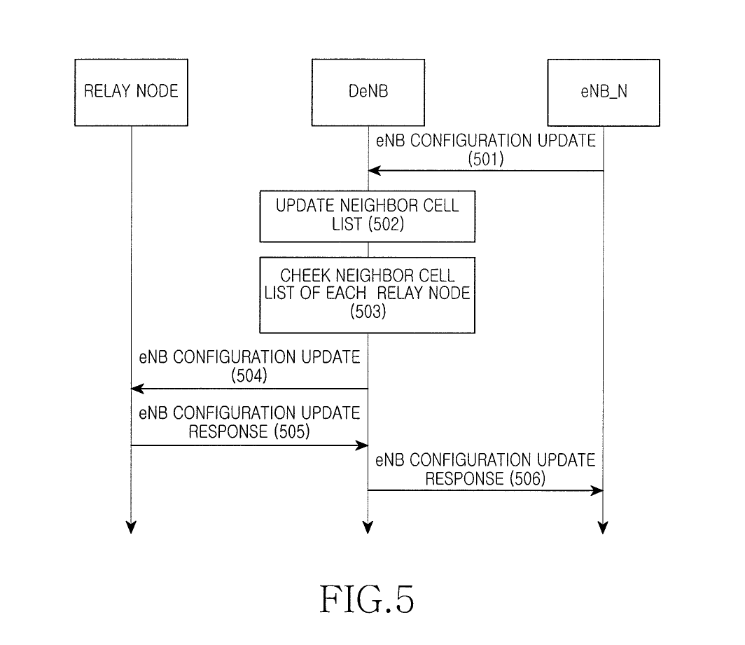

FIG. 5 is a signaling diagram for notifying the relay node when configuration information and/or load information of an eNB is changed according to an exemplary embodiment of the present invention. Here the eNB_N is only exemplary, and the neighboring node, such as another relay node, and the like, is also possible.

Referring to FIG. 5, in step 501, the configuration information and/or load information of the eNB_N is changed, and an eNB configuration update message is transmitted to the DeNB. The DeNB refers to the DeNB the neighboring cell of which or the neighboring cell of the subordinate relay node of which is the cell subordinate to the eNB_N. In this step, the eNB_N transmits an eNB state update message, in which the changed configuration information and/or load information are carried or the interference on different resource blocks by the neighboring cell can be carried, to the DeNB. The eNB state update message can specifically refer to the currently defined eNB load state message or the eNB configuration update message of the X2 message. It should be noted that another message, such as an eNB configuration update message, is also feasible.

In step 502, the DeNB determines whether the cell belonging to the eNB_N is presented in a neighboring cell list of the DeNB. If the cell belonging to the eNB_N is presented in the neighboring cell list of the DeNB, the DeNB updates its neighboring cell list according to the received eNB configuration update message and executes step 503. Otherwise, the cell belonging to the eNB_N is not presented in a neighboring cell list of the DeNB, step 503 is directly executed.

In step 503, with respect to the neighboring cell list of each subordinate relay node that the DeNB stores, the DeNB determines whether the cell belonging to the eNB_N is presented in the neighboring cell of the relay node. If the cell belonging to the eNB_N is presented in the neighboring cell of the relay node, step 504 is executed, or otherwise, the processing ends.

In step 504, the DeNB forwards the received eNB configuration update message to the relay node. In step 505, the relay node updates a neighboring cell list of the relay node according to the received eNB configuration update message, and transmits an eNB configuration update response message to the DeNB after the update is completed. In step 506, the DeNB transmits the eNB configuration update response message to the eNB_N. This step can also be executed before step 502.

In the two exemplary embodiments illustrated in FIGS. 4 and 5, the description is made from two sides. Hereinbelow, a processing procedure at a DeNB side is discussed in connection with an actual network deployment situation.

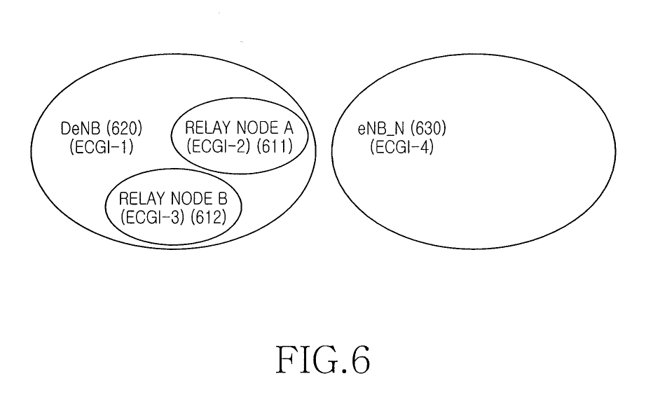

FIG. 6 is a schematic diagram illustrating a network deployment situation according to an exemplary embodiment of the present invention.

Referring to FIG. 6, two relay nodes, i.e., a relay node A 611 and a relay node B 612, are subordinate to a DeNB 620. A cell is subordinate to each relay node. The identifier of the cell subordinate to the DeNB 620 is ECGI-1, the identifier of the cell subordinate to the relay node A 611 is ECGI-2, the identifier of the cell subordinate to the relay node B 612 is ECGI-3, and the identifier of the cell subordinate to the eNB_N 630 is ECGI-4. The neighboring cell lists of the DeNB 620, the relay node A 611, and the relay node B 612 are as shown in Tables 1 through 3, respectively.

TABLE 1

| | Identifier | |
|---|---|---|
| Serial | of neighboring | Information |
| number | cell | of neighboring cell |
| 1 | ECGI-4 | TAC 1, PLMN 1 . . . |
| 2 | ECGI-2 | TAC 2, PLMN 1 . . . |
| 3 | ECGI-3 | TAC 3, PLMN 1 . . . |

TABLE 2

| | Identifier | |
|---|---|---|
| Serial | of neighboring | Information |
| number | cell | of neighboring cell |
| 1 | ECGI-1 | TAC 1, PLMN 1 . . . |
| 2 | ECGI-4 | TAC 4, PLMN 1 . . . |
| 3 | ECGI-3 | TAC 3, PLMN 1 . . . |

TABLE 3

| | Identifier | |
|---|---|---|
| Serial | of neighboring | Information |
| number | cell | of neighboring cell |
| 1 | ECGI-1 | TAC 1, PLMN 1 . . . |
| 2 | ECGI-2 | TAC2, PLMN 1 . . . |

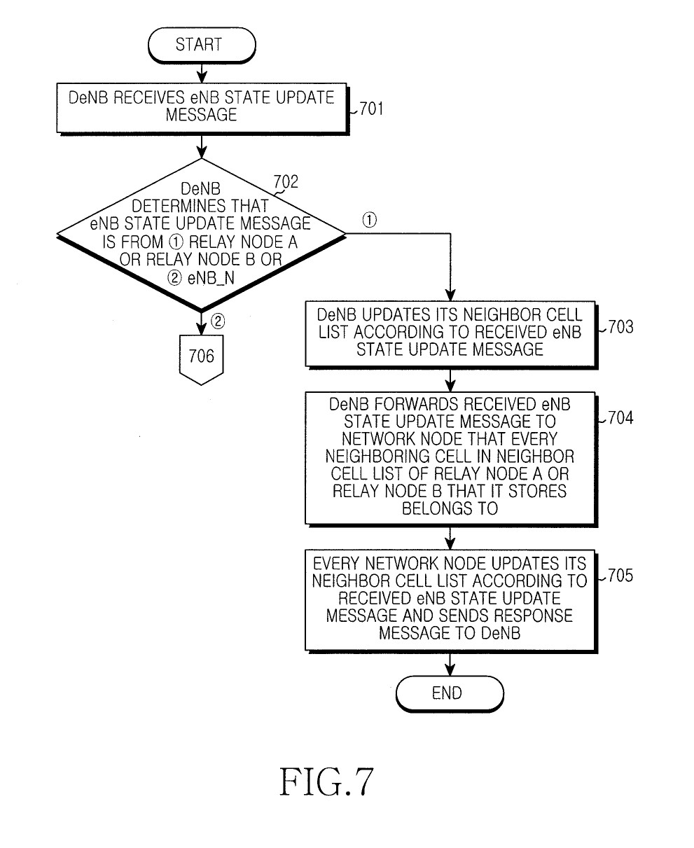

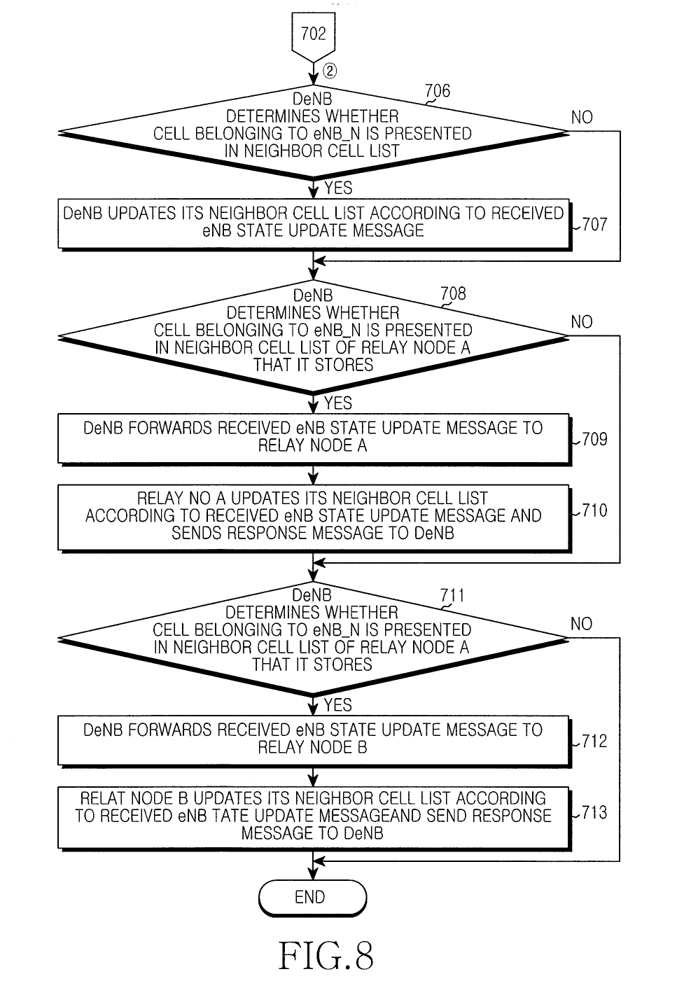

FIGS. 7 and 8 are flowcharts illustrating a processing manner after a DeNB receives an eNB state update message according to an exemplary embodiment of the present invention.

Referring to FIGS. 7 and 8, in step 701, the DeNB receives the eNB state update message, in which the changed configuration information and/or load information are carried.

In step 702, the DeNB determines that the eNB state update message is from the relay node A or the relay node B or the eNB_N, and if it is from the relay node A or the relay node B, step 703 is executed, or otherwise, step 706 is executed.

In step 703, the DeNB updates a neighboring cell list of the DeNB according to the received eNB state update message.

In step 704, the DeNB forwards the received eNB state update message to the network node that every neighboring cell in the neighboring cell list of the relay node A or the relay node B that it stores belongs to. If the relay node A transmits the eNB state update message, it can be known based on Table 2 that it is required to forward the eNB state update message to the relay node B and the eNB_N (except for the DeNB). If the relay node B transmits the eNB state update message, it can be known based on Table 3 that it is required to forward the eNB state update message to the relay node A.

In step 705, every network node updates its neighboring cell list according to the received eNB state update message and transmits a response message to the DeNB. Thereafter, the procedure ends.

If it is determined in step 702 that the eNB state update message is from the eNB_N, the DeNB determines, in step 706, whether the cell belonging to the eNB_N is presented in a neighboring cell list of the DeNB. If the cell belonging to the eNB_N is presented in the neighboring cell list of the DeNB, step 707 is executed, or otherwise, step 708 is executed. For example, the neighboring cell list of the DeNB is as shown as the Table 1, it can be known that the cell belonging to the eNB_N is presented in the neighboring cell list of the DeNB. If the cell belonging to the eNB_N is presented in the neighboring cell list of the DeNB, in step 707, the DeNB updates a neighboring cell list of the DeNB according to the received eNB state update message, and step 708 is executed.

In step 708, the DeNB determines whether the cell belonging to the eNB_N is presented in the neighboring cell list of the relay node A that the DeNB stores. If the cell is presented in the neighboring cell list of the relay node A, step 709 is executed. Otherwise, step 711 is executed. It can be known from Table 2 that the cell belonging to the eNB_N is presented in the neighboring cell list of the relay node A. In step 709, the DeNB forwards the received eNB state update message to the relay node A.

In step 710, the relay node A updates a neighboring cell list of the relay node A according to the received eNB state update message and transmits the response message to the DeNB.

In step 711, the DeNB determines whether the cell belonging to the eNB_N is presented in the neighboring cell list of the relay node B that the DeNB stores. If it is determined in step 711 that the cell is presented in the neighboring cell list of the relay node B, step 712 is executed. Otherwise, the procedure ends.

It can be known from Table 3 that the cell belonging to the eNB_N is not presented in the neighboring cell list of the relay node B. Therefore, there is no need to execute steps 712 and 713.

In step 712, the DeNB forwards the received eNB state update message to the relay node B.

In step 713, the relay node B updates a neighboring cell list of the relay node B according to the received eNB state update message and transmits the response message to the DeNB. Thereafter, the procedure ends.

The forgoing is only exemplary, and in the actual application, a sequence of steps 708 through 710 and steps 711 through 713 can be set freely.

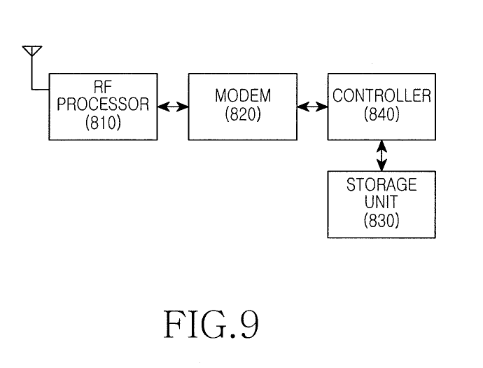

FIG. 9 is a block diagram of a relay node in a mobile communication system according to an exemplary embodiment of the present invention.

Referring to FIG. 9, the relay node includes a Radio Frequency (RF) processor 810, a modem 820, a storage unit 830 and a controller 840.

The RF processor 810 performs functions, such as signal band conversion and amplification, to transmit and receive signals over a radio channel. For example, the RF processor 810 up-converts a baseband signal output from the modem 820 into the RF signal and transmits the RF signal over an antenna, and down-converts the RF signal received over the antenna into the baseband signal. Although not illustrated, for example, the RF processor 810 may include an amplifier, a mixer, an oscillator, a Digital to Analog Convertor (DAC), an Analog to Digital Convertor (ADC), and the like.

The modem 820 converts the baseband signal and a bit string according to a physical layer standard of the system. For example, to transmit data, the modem 820 generates complex symbols by encoding and modulating a transmit bit string, maps the complex symbols to subcarriers, and constitutes Orthogonal Frequency-Division Multiplexing (OFDM) symbols by applying Inverse Fast Fourier Transform (IFFT) and inserting a Cyclic Prefix (CP). When receiving data, the modem 820 splits the baseband signal output from the RF processor 810 into OFDM symbols, restores the signals mapped to the subcarriers using Fast Fourier Transform (FFT), and restores the receive bit string by demodulating and decoding the signals.

The storage unit 830 stores program codes and system information required for the operations of the BS. Additionally, the storage unit 830 buffers data that are relayed between a subordinate node and an upper node. The storage unit 830 provides stored data to the controller 840 upon a request from the controller 840.

The controller 840 controls the functions of the relay node. For example, the controller 840 relays traffics from the subordinate node to the upper node and relays traffics from the upper node to the subordinate node. More particularly, the controller 840 reports to an eNB where the relay node subordinate to that a new neighboring cell is found when finding the new neighboring cell and updates a neighboring cell list. For example, the controller 840 controls so that the relay node operates as illustrated in FIGS. 3 through 5, 7, and 8.

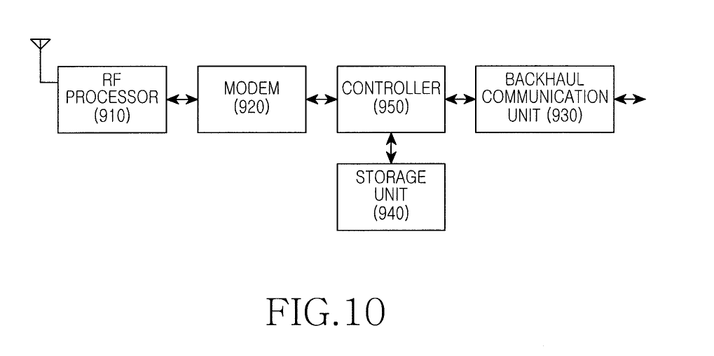

FIG. 10 is a block diagram of an eNB in a mobile communication system according to an exemplary embodiment of the present invention.

Referring to FIG. 10, the eNB includes an RF processor 910, a modem 920, a backhaul communication unit 930, a storage unit 940 and a controller 950.

The RF processor 910 performs functions, such as signal band conversion and amplification, to transmit and receive signals over a radio channel. For example, the RF processor 910 up-converts a baseband signal output from the modem 920 into the RF signal and transmits the RF signal over an antenna, and down-converts the RF signal received over the antenna into the baseband signal. Although not illustrated, for example, the RF processor 910 may include an amplifier, a mixer, an oscillator, a DAC, an ADC, and the like.

The modem 920 converts the baseband signal and a bit string according to a physical layer standard of the system. For example, to transmit data, the modem 920 generates complex symbols by encoding and modulating a transmit bit string, maps the complex symbols to subcarriers, and constitutes OFDM symbols by applying IFFT and inserting a CP. When receiving data, the modem 920 splits the baseband signal output from the RF processor 910 into OFDM symbols, restores the signals mapped to the subcarriers using FFT, and restores the receive bit string by demodulating and decoding the signals.

The backhaul communication unit 930 provides an interface for the eNB to communicate with other entities (i.e., other eNBs, an MME, and the like). More specifically, the backhaul communication unit 930 converts the bit string transmitted by the BS into a physical signal, and converts the physical signal received at the BS into the bit string. For example, the backhaul communication unit 930 supports an X2 interface. The storage unit 940 stores program codes and system information required for the operations of the eNB. The storage unit 940 provides stored data to the controller 950 upon a request from the controller 950.

The controller 950 controls the functions of the eNB. For example, the controller 950 generates a transmit packet and a message and provides the modem 920 with the transmit packet and the message. The controller 950 also processes a receive packet and a message from the modem 920. More particularly, the controller 950 sets up an X2 interface between the eNB and a network node that a new neighboring cell belongs to and is found by a relay node. In addition, the controller 950 adds information of the new neighboring cell into neighboring cell list. For example, the controller 950 controls so that the eNB operates as illustrated in FIGS. 3, through 5, 7, and 8.

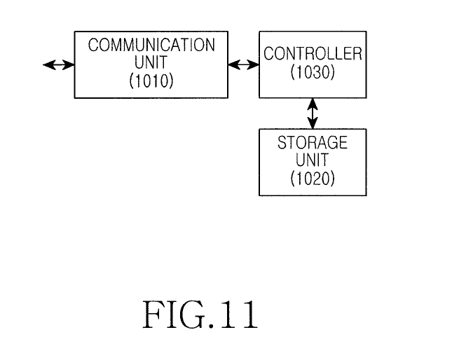

FIG. 11 is a block diagram of an MME in a mobile communication system according to an exemplary embodiment of the present invention.

Referring to FIG. 11, the MME includes a communication unit 1010, a storage unit 1020, and a controller 1030.

The communication unit 1010 provides an interface for a gateway to communicate with other entities (i.e., an eNB, and the like). The storage unit 1020 stores program codes and system information required for the operations of the gateway.

The controller 1030 controls the functions of the gateway. For example, the controller 1030 manages a traffic flow of at least one small eNB connected to the MME. More particularly, the controller 1030 controls a procedure for setting up an X2 interface between an eNB and a network node. For example, the controller 1030 controls so that the MME operates as illustrated in FIGS. 3 through 5, 7, and 8.

In conclusion, it is realized that the relay node can communicate with the network node that the new neighboring node belongs to through the DeNB. In addition, it can also be realized that when the configuration information and/or load information of the relay node is changed, the neighboring node is timely notified through the DeNB, and when the configuration information and/or load information of the neighboring node is changed, the relay node is timely notified through the DeNB.

Exemplary embodiments of the present invention, according to the claims and description in the specification, can be realized in the form of hardware, software or a combination of hardware and software.

Such software may be stored in a computer readable storage medium. The computer readable storage medium stores one or more programs (i.e., software modules) comprising instructions, which when executed by one or more processors in an electronic device, cause the electronic device to perform exemplary methods of the present invention.

Such software may be stored in the form of volatile or non-volatile storage, such as a Read Only Memory (ROM), which may be erasable or rewritable, or in the form of memory, such as a Random Access Memory (RAM), memory chips, device or integrated circuits or on an optically or magnetically readable medium, such as a Compact Disc (CD), a Digital Video Disc (DVD), a magnetic disk, a magnetic tape, or the like. It will be appreciated that the storage devices and storage media are exemplary embodiments of machine-readable storage that are suitable for storing a program or programs comprising instructions that, when executed, implement exemplary embodiments of the present invention. Exemplary embodiments provide a program comprising code for implementing an apparatus or a method as claimed in any one of the claims of this specification and a machine-readable storage storing, such as a program. Moreover, such programs may be conveyed electronically via any medium, such as a communication signal carried over a wired or wireless connection and exemplary embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for setting up a communication relationship in a mobile communication system, the method comprising:
A. obtaining information, by a relay node, of a new neighboring cell, and reporting the information of the new neighboring cell to a Donor evolved Node B (DeNB) that the relay node is subordinate to; and
B. finding, by the DeNB, a network node that the new neighboring cell belongs to, determining whether an X2 interface is set up between the DeNB and the network node that the new neighboring cell belongs to, and if it is determined that the X2 interface is not set up with the network node, setting up the X2 interface with the network node that the new neighboring cell belongs to.

2. The method of claim 1, wherein the obtaining of the information of the new neighboring cell and the finding of the network node that the new neighboring cell belongs to comprises:
receiving, by the relay node, a measurement report transmitted from a subordinate User Equipment (UE), determining whether a physical-layer identifier of a neighboring cell that is carried in the measurement report is presented in a neighboring cell list of the relay node, and determining the neighboring cell corresponding to the physical-layer identifier not presented in the neighboring cell list as the new neighboring cell; and
notifying, by the relay node, the subordinate UE to report the information of the new neighboring cell, and receiving the information of the new neighboring cell that is returned from the subordinate UE.

3. The method of claim 1, wherein the information of the new neighboring cell includes: an Evolved Universal Terrestrial Radio Access Network (E-UTAN) Cell Global Identifier (ECGI), a Tracking Area Code (TAC), and a Public Land Mobile Network Identifier (PLMN ID).

4. The method of claim 1, wherein the setting up of the X2 interface with the network node that the new neighboring cell belongs to comprises:
transmitting, by the DeNB, an eNB configuration transmission message to a Mobile Management Entity (MME), transmitting, by the MME, an MME configuration transmission message to the network node that the new neighboring cell belongs to, and transmitting, by the network node that the new neighboring cell belongs to, the eNB configuration transmission message to the MME; and
transmitting, by the MME, the MME configuration transmission message to the DeNB, transmitting, by the DeNB, an X2 setup request message to the network node that the new neighboring cell belongs to, transmitting, by the network node that the new neighboring cell belongs to, an X2 setup response message to the DeNB, and transmitting, by the DeNB, a neighboring cell information notification message to the relay node.

5. The method of claim 2, wherein the neighboring cell list of the relay node is stored in the DeNB, and wherein the DeNB adds the information of the new neighboring cell into the stored neighboring cell list of the relay node in which the new neighboring cell is found.

6. The method of claim 1, further comprising:
if it is determined that the X2 interface has been set up between the DeNB and the network node that the new neighboring cell belongs to, transmitting by the DeNB, a neighboring cell information notification message to the relay node.

7. The method of claim 5, further comprising:
C. determining, by the DeNB, whether an eNB state update message is received, where changed configuration information and/or load information are carried in the eNB state update message, if the eNB state update message is received, determining that the eNB state update message is received from the subordinate relay node or another network node, and if it is determined that the eNB state update message is received from the subordinate relay node, executing step D, and if it is determined that the eNB state update message is not received from the subordinate relay node, executing step E;
D. updating, by the DeNB, the neighboring cell list of the DeNB according to the received eNB state update message, forwarding the eNB state update message to the network node that every neighboring cell in the stored neighboring cell list of the relay node belongs to, and transmitting the eNB state update message;
E. determining, by the DeNB, whether the cell belonging to the network node transmitting the eNB state update message is presented in the neighboring cell list of the DeNB, and if it is determined that the cell is presented in the neighboring cell list, updating the neighboring cell list according to the eNB state update message and executing step F, and if it is determined that the cell is not presented in the neighboring cell list, directly executing step F; and
F. determining, by the DeNB, with respect to the stored neighboring cell list of each subordinate relay node, whether the cell belonging to the network node transmitting the eNB state update message is presented in the neighboring cell of the relay node, and if it is determined that the cell is presented in the neighboring cell of the relay node, forwarding the eNB state update message to the relay node.

8. A method for an operation of a relay node in a mobile communication system, the method comprising:
obtaining information of a new neighboring cell; and
reporting the information of the new neighboring cell to a Donor evolved Node B (DeNB) that the relay node is subordinate to.

9. The method of claim 8, wherein the obtaining of the information of the new neighboring cell comprises:
receiving a measurement report transmitted from a subordinate User Equipment (UE);
determining whether a physical-layer identifier of a neighboring cell that is carried in the measurement report is presented in a neighboring cell list of the relay node; and
determining the neighboring cell corresponding to the physical-layer identifier not presented in the neighboring cell list as the new neighboring cell.

10. A method for an operation of an evolved Node B (eNB) in a mobile communication system, the method comprising:
finding a network node that a new neighboring cell belongs to when information of the new neighboring cell is reported from a relay node subordinate to the eNB;
determining whether an X2 interface is set up between the eNB and the network node that the new neighboring cell belongs to; and
setting up the X2 interface with the network node that the new neighboring cell belongs to upon determining that the X2 interface is not set up.

11. The method of claim 10, wherein the setting up of the X2 interface comprises,
transmitting an eNB configuration transmission message comprising an indication for requesting a transmission-layer address of the network node to a Mobile Management Entity (MME);
receiving an MME configuration transmission message comprising the transmission-layer address of the network node from the MME;
transmitting an X2 setup request message to the network node using comprising the transmission-layer address;
receiving an X2 setup response message from the network node; and
transmitting a neighboring cell information notification message to the relay node.

12. The method of claim 10, wherein a neighboring cell list of the relay node and at least one neighboring cell list of every subordinate relay node are stored in the DeNB, and wherein the information of the new neighboring cell is added into the stored neighboring cell list of the relay node in which the new neighboring cell is found.

13. The method of claim 8, wherein the information of the new neighboring cell includes: an Evolved Universal Terrestrial Radio Access Network (E-UTAN) Cell Global Identifier (ECGI), a Tracking Area Code (TAC), and a Public Land Mobile Network Identifier (PLMN ID).

14. An apparatus for operating a relay node in a mobile communication system, the apparatus comprising:
a controller for obtaining information of a new neighboring cell; and
a modem for reporting the information of the new neighboring cell to a Donor evolved Node B (DeNB) that the relay node is subordinate to.

15. An apparatus for operating an eNB in a mobile communication system, the apparatus comprising:
a modem for receiving information of a new neighboring cell from a relay node subordinate to the eNB; and
a controller for finding a network node that the new neighboring cell belongs to, for determining whether an X2 interface is set up between the eNB and the network node that the new neighboring cell belongs to, and for setting up the X2 interface with the network node that the new neighboring cell belongs to upon determining that the X2 interface is not set up.

16. The apparatus of claim 14, wherein the controller receives a measurement report transmitted from a subordinate User Equipment (UE), determines whether a physical-layer identifier of a neighboring cell that is carried in the measurement report is presented in a neighboring cell list of the relay node, and determines the neighboring cell corresponding to the physical-layer identifier not presented in the neighboring cell list as the new neighboring cell.

17. The apparatus of claim 14, wherein the information of the new neighboring cell includes an Evolved Universal Terrestrial Radio Access Network (E-UTAN) Cell Global Identifier (ECGI), a Tracking Area Code (TAC), and a Public Land Mobile Network Identifier (PLMN ID).

18. The apparatus of claim 15, wherein the setting up of the X2 interface comprises,
transmitting an eNB configuration transmission message comprising an indication for requesting a transmission-layer address of the network node to a Mobile Management Entity (MME);
receiving an MME configuration transmission message comprising the transmission-layer address of the network node from the MME;
transmitting an X2 setup request message to the network node comprising the transmission-layer address;
receiving an X2 setup response message from the network node; and
transmitting a neighboring cell information notification message to the relay node.

19. The apparatus of claim 15, wherein a neighboring cell list of the relay node and at least one neighboring cell list of every subordinate relay node are stored in the DeNB, and wherein the information of the new neighboring cell is added into the stored neighboring cell list of the relay node in which the new neighboring cell is found.

20. The apparatus of claim 15, wherein the information of the new neighboring cell includes an Evolved Universal Terrestrial Radio Access Network (E-UTAN) Cell Global Identifier (ECGI), a Tracking Area Code (TAC), and a Public Land Mobile Network Identifier (PLMN ID).

21. The method of claim 10, wherein the information of the new neighboring cell includes an Evolved Universal Terrestrial Radio Access Network (E-UTAN) Cell Global Identifier (ECGI), a Tracking Area Code (TAC), and a Public Land Mobile Network Identifier (PLMN ID).

22. The method of claim 10, further comprising:
if it is determined that the X2 interface has been set up between the eNB and the network node that the new neighboring cell belongs to, transmitting by the eNB, a neighboring cell information notification message to the relay node.

23. The method of claim 9, wherein a neighboring cell list of the relay node and at least one neighboring cell list of every subordinate relay node are stored in the DeNB, and wherein the information of the new neighboring cell is added into the stored neighboring cell list of the relay node.
